(19) United States
(12) Patent Application Publication
(10) Pub. No.: US 2022/0114017 A1
(43) Pub. Date: Apr. 14, 2022

(54) REMAPPING ELEMENTS BASED ON A TRANSITION OF DEVICE STATES

(71) Applicant: Hewlett-Packard Development Company, L.P., Spring, TX (US)

(72) Inventor: Christoph Graham, Spring, TX (US)

(73) Assignee: Hewlett-Packard Development Company, L.P., Spring, TX (US)

(21) Appl. No.: 17/419,221

(22) PCT Filed: May 31, 2019
(86) PCT No.: PCT/US2019/034956

§ 371 Date: Jun. 28, 2021

(51) Int. Cl. G06F 9/50

(52) U.S. Cl. CPC G06F 9/50

(57) ABSTRACT

In an example implementation according to aspects of the present disclosure, a method may include determining whether a device has transitioned from a first state to a second state and, upon determining the device has transitioned to the second state, remapping an element of a web-based application executing on the device to a localized resource stored on the device.

### BACKGROUND

Web-based applications, applications utilizing a browser framework and JavaScript as an example, is resident an, and may be executed by, one or more server computers on the World Wide Web, responsive to inputs provided from a client device communicatively coupled over the Internet to the web-based application. As an example, the web-based application may be resident on and hosted by a single server computer, or portions may be split or shared among multiple websites/webpages hosted on different servers. Web-based applications may expose their user interface via a web browser client and have no installation on the client device. Rather, web-based applications may rely on the application server, not the client, to implement the features of the web-based application, and to manage access to the data on the server before it is transmitted to the client. As an example, the client device may couple to the web-based application by directing the web browser to the uniform resource locator (URL) for the web-based application. In such web-based applications, business logic may be run at the server, not at the client device.

### BRIEF DESCRIPTION OF THE DRAWINGS

FIG. 1 illustrates a system including a server communicatively coupled to a client device via a network, according to an example;

FIG. 2 illustrates a client device including a web browser to render a document object model (DOM) for a web page received from a web-based application executed on a server, according to an example; and

FIG. 3 is a flow diagram in accordance with an example of the present disclosure.

### DETAILED DESCRIPTION

Examples disclosed herein provide a system for collecting, managing, and updating content corresponding to a web-based application, so that the web-based application is readily available from a client device and usable for offline consumption and interaction. As a result, as users continue to rely on web-based applications and data, the examples described herein allow for the capture and interaction with web-based content of a web-based application in an offline or disconnected manner. The system allowing for the consumption of specified web content in an offline or disconnected capacity may work independently of the web-based application back end infrastructure or application composition. As an example, by recreating a representation of the document object model (DOM) of the web-based application and the application code creating behaviors on that DOM, interactivity of elements of the web-based application may be better understood and remapped to localized resources on a client device, for example, when the client device is disconnected from the Internet. As a result, functionality of the web-based application on the client device may be maintained. As will be further described, the web-based content of the web-based application may be kept up-to-date as access to the Internet and the web-based application become available.

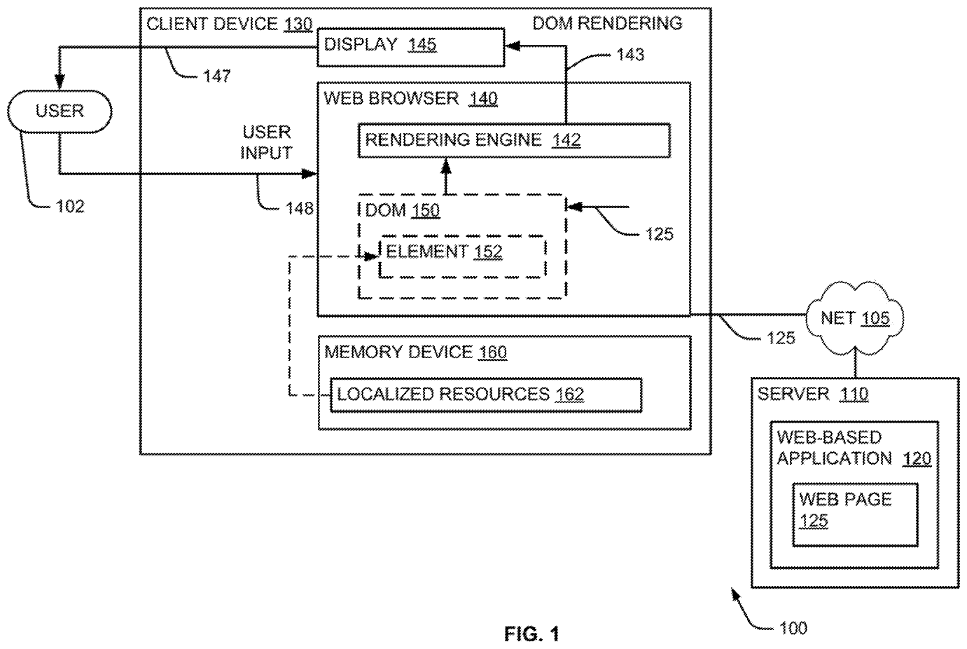

With reference to the figures, FIG. 1 illustrates a system 100 including a server 110 communicatively coupled to a client device 130 via a network 105, according to an example. In one example, the network 105 is the Internet. In other examples, the network 105 may be different from the Internet. The server 110 hosts and executes a web-based application 120. In some examples, the web-based application 120 is an HTTP-based application. As an example, an “HTTP-based application” may be broadly understood to encompass a web-based application in which the communications between the server executing the application and a client accessing the application are carried out by hypertext transfer protocol (HTTP) or hypertext transfer protocol secure (HTTPS). The application 120 generates at least one web page 125, which is transmitted over the network 105 to the client device 130. As an example, the web page 125 is a document of elements or objects of a markup language, such as HTML (hypertext markup language), XHTML (extensible hypertext markup language), and/or XML (extensible markup language). Different web pages, or different content of a particular web page, may be transmitted from the server 110 to the client device 130 from time to time as modified by the execution of the application, or in response to interactions by a user 102 of the client device 130 with the application 120.

The client device 130 includes a web browser 140 that receives the web page 125. The received web page is stored in the browser 140 as a document object model 150 of the web page 125. As an example, a “document object model” (or “DOM”) may be broadly understood to mean a convention for representing and interacting with objects of HTML, XHTML, and XML documents, such as web pages. As an example, a rendering engine 142 of the browser 140 accesses the DOM 150 and generates rendered output 143 to a display 145 where it is viewable by the user 102 in visual form 147 as a graphical user interface (GUI). The user 102 may interact with the client device 130 through the GUI to supply user input 148 to the browser 140. Examples of user input 148 include the user 102 selecting a DOM element, selecting one of a set of multiple page views (e.g., page tabs), and entering data into a text box, among many others.

As an example, a “DOM element” may be broadly understood to mean an element of an HTML or XHTML document, such as a web page, or a node of an XML document, that is represented according to the DOM model (e.g., element 152 of DOM 150). Properties of a DOM element 152 may include one or more visual characteristics defining how the element 152 is to be rendered by the web browser 140. As an example, there may be visual properties for font-size, color, background appearance, and so on. Attributes of a DOM element 152 may include one or more tags (or properties) that each define a characteristic of an element. Such tags may include, among others, a class tag that may identify the type of the element, an ID tag that may assist in locating an element, and an action tag that may specify an action to be taken by the web browser 140 in response to the element 152 being selected. Selection may occur in a variety of ways, including but not limited to changing focus to, mousing over, clicking on, right-clicking on, or touching. A data value of an element 152 may be, in one example, a text string or numeric value for the element.

As mentioned above, it may be desirable to continue use of the web-based application 120 via the client device 130, even when the client device 130 is disconnected from the server 110. For example, the client device 130 may be used at times in an offline manner, or with no network access, for example, via network 105, to the server 110. Therefore, while the client device 130 is offline or in a disconnected manner, certain elements 152 of the DOM 150, which include interactivity with web content resources while the client device 130 is communicatively coupled to the server 110, may be remapped to localized resources 162, for example, stored in a memory device 160 of the client device 130. As will be further described, these certain elements 152 having interactivity with web content resources may be identified and remapped to localized resources 162 when the client device 130 is operated in a disconnected manner. As a result, functionality of the web-based application 120 on the client device 130 may be maintained, as will be further described. As an example, the localized resources 162 may be kept up-to-date as access to the Internet, via the network 105, and the web-based application 120 become available. In addition to the localized resources 162, data such as the DOM 150, may also be stored in the memory device 160 of the client device 130.

As described above, the web page 125 is a document of elements or objects of a markup language, such as HTML, XHTML, and/or XML. As an example, element 152—of DOM 150 may refer to an element of the HTML or XHTML document, such as the web page 125, or a node of an XML document, that is represented according to the DOM model. As a result, the DOM 150 may include a number of elements 152 while the rendering engine 142 accesses the DOM 150 and generates rendered output 143. As an example, generating the rendered output 143 allows the client device 130 to understand all the underlying elements 152 of the DOM 150 and web content resources, and their positions within the rendered output 143 and interactivity requirements associated with each element 152. Recreating a representation of the web page 125 by rendering the DOM 150 allows far the client device 130 to understand the structure of the web-based application 120 by resources, content, application programming interface, user ability or activity requirements, and user session and authorization requirements.

The client device 130 may then pair this knowledge with application client-side code (e.g., JavaScript), which may provide web application interactivity from the web browser 140. Upon inspecting the domains where elements 152 may interact with web content resources, for example, by evaluating the DOM resource representation and an abstract syntax tree representation of the JavaScript that is required by the client device 130, the client device 130 may then determine which JavaScript elements are relevant to maintaining interactivity with certain DOM elements 152. Upon determining the relevant JavaScript elements to maintaining interactivity with certain DOM elements 152 when the client device 130 is being operated in a disconnected manner, the client device 130 may create queries for relevant artifacts, such as continuing content via API that need to be cached, and also provide any updates to the JavaScript syntax tree representation by remapping the relevant JavaScript elements to the localized resources 162. As a result, while being operated in a disconnected manner, the client device 130 may recreate the web-based application 120 and its resource from the localized resources 162 while continuing to provide application interactivity that the user 102 is expecting. For example, the content look of elements 152 within the rendered output 143, and its position within the page, may not be impacted while the client device 130 is operated in a disconnected manner. As an example, upon the client device 130 reconnecting to the network 105, and communicatively coupled to the server 110, the elements 152 of the DOM 150 remapped to the localized resources 162 may map back to the web content resources. In addition, the localized resources 162 may be kept up-to-date upon the client device 130 reconnecting to the network 105.

As an example, the determinations for which elements 152 to remap to localized resources 162, and which localized resources 162 to utilize for remapping may be defined via a policy. As defined herein, a “policy” (or “policy control hook”) may be broadly understood to mean a mechanism on the client device 130 for enforcing a predefined policy during interactions with the web-based application 120.

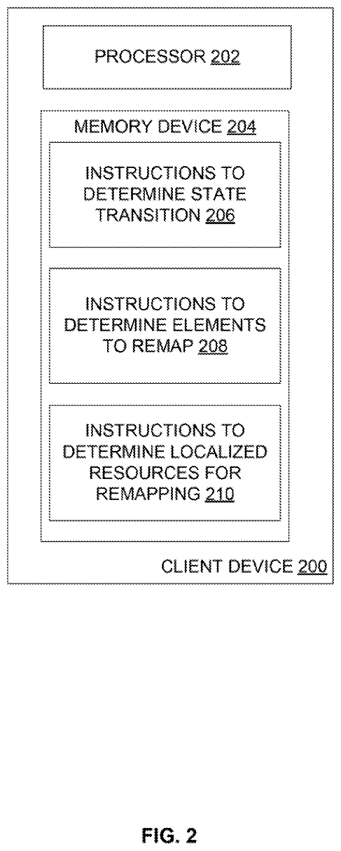

FIG. 2 illustrates a client device 200 including a web browser to render a DOM for a web page received from a web-based application executed on a server, according to an example. The client device 200 may correspond to the client device 130 illustrated in FIG. 1, and reference may be made to them. The client device 200 depicts a processor 202 and a memory device 204 and, as an example of the client device 200 performing its operations, the memory device 204 may include instructions 206-210 that are executable by the processor 202. Thus, memory device 204 can be said to store program instructions that, when executed by processor 202, implement the components of the client device 200. The executable program instructions stored in the memory device 204 include, as an example, instructions to determine state transition (206), instructions to determine elements to remap (208), and instructions to determine localized resources for remapping (210).

Instructions to determine state transition (206) represent program instructions that when executed by the processor 202 cause the client device 200 to determine whether it has transitioned from a first state to a second state. As an example, the first state may correspond to a connected state and the second state may correspond to a disconnected state, such as whether client device 130 of FIG. 1 is connected to or disconnected from network 105. However, the first and second states of the client device 200 may correspond to other states as well. For example, the first state may correspond to whether the client device 200 is in a first locality state and the second state may correspond to whether the client device 200 is in a second locality state different from the first locality state. As an example, locality may refer to geolocations (e.g., whether the client device 200 is in a first or second geolocation), whether the network that the client device 200 is connected to is public (first locality state) or private (second locality state), or whether the network that the client device 200 is connected to is wired (first locality state) or wireless (second locality state).

Instructions to determine elements to remap (208) represent program instructions that when executed by the processor 202 cause the client device 200, upon determining the client device 200 has transitioned to the second state, to determine which elements of a web-based application executing on the client device 200 to remap to localized resources stored on the client device 200. As described above, certain elements of the DOM of the web page generated by the web-based application may be identified for remapping, which may include interactivity with web content resources.

Instructions to determine localized resources for remapping (210) represent program instructions that when executed by the processor 202 cause the client device 200, for each element of the elements to remap, to determine which localized resources to utilize for remapping. As an example, the determinations for which elements to remap and which localized resources to utilize for remapping y be defined via a policy.

Memory device 204 represents generally any number of memory components capable of storing instructions that can be executed by processor 202. Memory device 204 is non-transitory in the sense that it does not encompass a transitory signal but instead is made up of at least one memory component configured to store the relevant instructions. As a result, the memory device 204 may be a non-transitory computer-readable storage medium. Memory device 204 may be implemented in a single device or distributed across devices. Likewise, processor 202 represents any number of processors capable of executing instructions stored by memory device 204. Processor 202 may be integrated in a single device or distributed across devices. Further, memory device 204 may be fully or partially integrated in the same device as processor 202, or it may be separate but accessible to that device and processor 202.

In one example, the program instructions 206-210 can be part of an installation package that when installed can be executed by processor 202 to implement the components of the client device 200. In this case, memory device 204 may be a portable medium such as a compact disc (CD), digital versatile disc (DVD), or flash drive or a memory maintained by a server from which the installation package can be downloaded and installed. In another example, the program instructions may be part of an application or applications already installed. Here, memory device 204 can include integrated memory such as a hard drive, solid state drive, or the like.

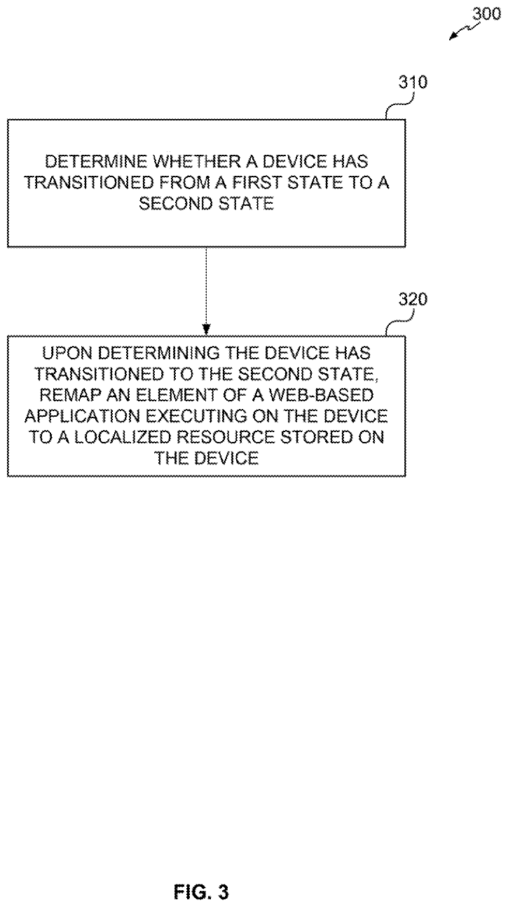

FIG. 3 is a flow diagram 300 taken by a device, such as a client device, to implement a method for accessing a web-based application in an offline or disconnected manner, according to an example. Although the flow diagram of FIG. 3 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

At 310, the device determines whether it has transitioned from a first state to a second state. As an example, the first state corresponds to a connected state and the second state corresponds to a disconnected state. As an example, the first state corresponds to the device in a first locality state and the second state corresponds to the device in a second locality state.

At 320, upon determining the device has transitioned to the second state, the device remaps an element of a web-based application executing on the device to a localized resource stored on the device. As a result, by remapping the element to the localized resource, functionality of the web-based application may be maintained while the device is in the second state. As an example, while the device is in the first state, the element may include interactivity with web content resources. As a result, the localized resources may be kept up-to-date, according to the web content resources. As an example, upon determining the device has transitioned back to the first state, the device may remap the element of the web-based application executing on the device to the web content resources.

As an example, the device may determine which elements of the web-based application to remap upon determining the device has transitioned to the second state, and for each element of the elements to remap, the device may determine which localized resources stored on the device to utilize for remapping. The determinations for which elements to remap and which localized resources to utilize for remapping may be defined via a policy.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A method comprising:
determining whether a device has transitioned from first state to a second state; and
upon determining the device has transitioned to the second state, remapping an element of a web-based application executing on the device to a localized resource stored on the device.

2. The method of claim 1, wherein the element comprises interactivity with web content resources while the device is in the first state.

3. The method of claim 2, wherein upon determining the device has transitioned back to the first state, remapping the element of the web-based application executing on the device to the web content resources.

4. The method of claim 2, wherein while the device is in the first state, updating the localized resource according to the web content resources.

5. The method of claim 1, wherein remapping the element to the localized resource comprises maintaining a functionality of the web-based application while the device is in the second state.

6. The method of claim 1, wherein the first state comprises a connected state and the second state comprises a disconnected state.

7. The method of claim 1, wherein the first state comprises the device in a first locality state and the second state comprises the device in a second locality state.

8. The method of claim 1 comprising:
determining which elements of the web-based application to remap upon determining the device has transitioned to the second state; and
for each element of the elements to remap, determining which localized resources stored on the device to utilize for remapping.

9. The method of claim 8, wherein the determinations for which elements to remap and which localized resources to utilize for remapping are defined via a policy.

10. A client device comprising:
a web browser to render a document object model (DOM) for a web page received from a web-based application executed on a server;
a memory device; and
a processor to:
determine whether the client device has transitioned from a connected state to the server to a disconnected state from the server; and
upon determining the device has disconnected from the server, remap an element of a web-based application executing on the client device to a localized resource stored on the memory device.

11. The client device of claim 10, wherein the web browser comprises a rendering engine for rendering the DOM on a display of the client device.

12. The client device of claim 10, wherein the processor is to:
determine which elements of the web-based application to remap upon determining the device has transitioned to the second state; and
for each element of the elements to remap, determine which localized resources stored on the device to utilize for remapping.

13. The client device of claim 12, wherein the determinations for which elements to remap and which localized resources to utilize for remapping are defined via a policy.

14. A non-transitory computer-readable storage medium comprising program instructions which, when executed by a processor of a client device, cause the processor to:
determine whether the client device has transitioned from a first state to a second state;
upon determining the client device has transitioned to the second state determine which elements of a web-based application executing on the client device to remap to localized resources stored on the client device; and
for each element of the elements to remap, determine which localized resources to utilize for remapping.

15. The non-transitory computer-readable storage medium of claim 14, wherein the first state comprises a connected state and the second state comprises a disconnected state.
